(19) United States
(12) Patent Application Publication
(10) Pub. No.: US 2003/0035686 A1
(43) Pub. Date: Feb. 20, 2003

(54) Rail slide bar

(76) Inventor: Danny Daeho Lee, Poway, CA (US)

Correspondence Address: Danny Lee, 14105 Willow Ranch Rd, Poway, CA, 92064, US

(21) Appl. No.: 09/872,951

(22) Filed: Aug. 15, 2001

(51) Int. Cl. F16D 1/00; B25G 3/00; F16B 7/10

(52) U.S. Cl. 403/379.5

(57) ABSTRACT

A skateboard rail is metal tubing welded on top of legs also made of metal which hold the tubing above ground level. The legs are welded to base plates which are also made of metal and prevent the railslide bar from tipping over. The legs can be adjustable by placing a smaller leg into a larger leg and held in place by putting a pin or bolt in the aligned holes. The skateboard rail provides as an obstacle which skateboarders or rollerbladers or bicycles can perform tricks on by sliding across the top surface.

The skateboard rail is an obstacle that the skateboarder performs tricks on. The skateboarder will jump on this obstacle with the skateboard beneath their feet and slide across the top surface. The skateboard rail can be made adjustable to different heights or angles.

Specification—Metal tubing is cut and welded on two legs which are also metal tubing of shorter length. The legs hold the tubing above ground level. The legs are welded on to metal plates which make the base. The purpose of the plates is to prevent the slider bar from falling over. The legs can be made adjustable by inserting the steel tubing into another steel tubing slightly larger. The height can be locked in place by inserting a metal bolt or metal pin in the holes of the leg. The leg has multiple holes to adjust the sliderbar at different heights from the ground.

Background—field of invention—This invention relates to slidable metal skateboard rails. Specifically, it relates to such rails for performing tricks on a skateboard with as an obstacle.

Background—discussion of prior art—skateboarders and rollerbladers perform tricks on benches, ledges, and handrails. This rail replaces those obstacles which were not intended for skateboarders.

1 Benches, ledges, and handrails get scratched and chipped due to the rider sliding on the surface.

2 This metal rail is composed of steel instead of cement and is more resilient to chipping and provides a surface that has less friction than cement.

3 This slidable metal skateboard rail is portable which enables the skateboarder to skate at almost any location.

4 This rail can be made adjustable to different heights so the rider can slide at different heights and angles.

Summary of the Invention—the adjustable skateboard rail comprises of metal tubing welded on top of legs which are inserted into slots which are slightly larger and held in place with metal pins or bolts. The legs are welded to metal plates for support from falling over.

Summary of the Invention—Objects and Advantages—Accordingly, besides the objects and advantage of the metal rail described in my patent, several objects and advantages of the present invention are

a) To provide an obstacle that the rider can own instead of damaging public or private property

b) To provide an obstacle that is portable for the rider to slide at various locations

c) To provide an obstacle which has a surface that is slidable and is more resilient to cracking.

d) To provide an obstacle that is adjustable that can be set at different heights, thus making it slidable for beginners to advanced riders and to provide different angled sliding surfaces.

e) To provide an obstacle that is stable and not tip over when jumped on.

### DESCRIPTION OF THE DRAWINGS

FIG. 1 shows the adjustable skateboard rail at medium height. Part 1 is the metal tubing that is intended for sliding across. Part 2 are the legs which are welded to part 1. There are holes in part 2 for inserting the pin. Part 3 are the legs which are slightly larger in diameter than part 2. Part 2 is partially inside of part 3. Part 3 has holes in it to insert the pin. Part 3 is welded to part 4. Part 4 are the base plates made of metal. They provide the support of the skateboard rail from falling over.

FIG. 2 shows the leg assembly taken apart. Part 1 is the slidable metal tubing. Part 2 is the leg with holes that is welded to part 1. Part 2 is inserted into part 3. Part 3 is also part of the leg and also has holes in it. Part 3 is welded to part 4 the base plates. To adjust the desired height of the skateboard rail, part 2 is inserted into part 3. Part 5 is a pin or screw made of metal. The screw or pin is placed into the aligned holes of part 3 and part 2. This prevents part 2 from sliding down any further into part 3.

FIG. 3A shows the frontal view of the leg assembly when taken apart.

FIG. 3B shows the frontal view of the leg assembly when the pin or bolt is placed in the aligned holes to achieve the desired height. Part 1 is the sliding surface. Part 2 is the smaller of the leg assembly welded to part 1. Part 3 is the the larger of the leg assembly welded to the base plate part 4. The screw or pin is part 5 which is going through part 3 and part 2.

FIG. 4A is a side view of the skateboard rail. It is set at a medium height.

FIG. 4B is a side view of the skateboard rail. It is set at a low height. Part 2 can not be seen since it is inside of part 3.

FIG. 4C is a side view of the skateboard rail. It is set at an angle. On the right side of the rail, part 2 is inside of part 3. On the left side, part 2 is only slightly in part 3 and held in place by part 5. Part 5 is the bolt or pin that is inserted in the aligned holes of part 2 and 3 and prevents part 2 from sliding inside of part 3.

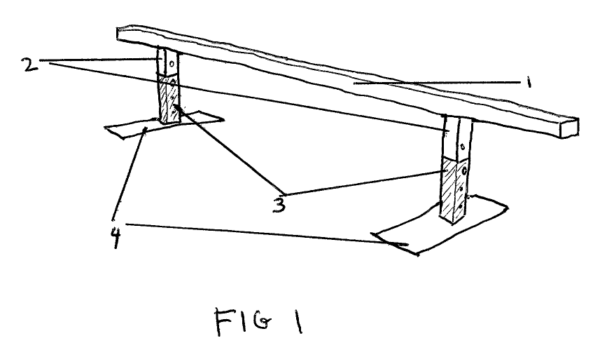

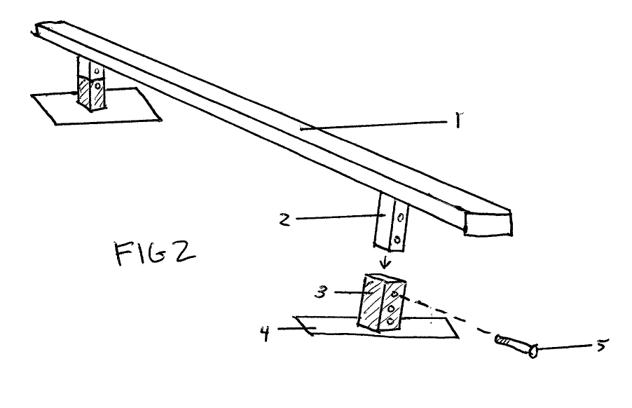

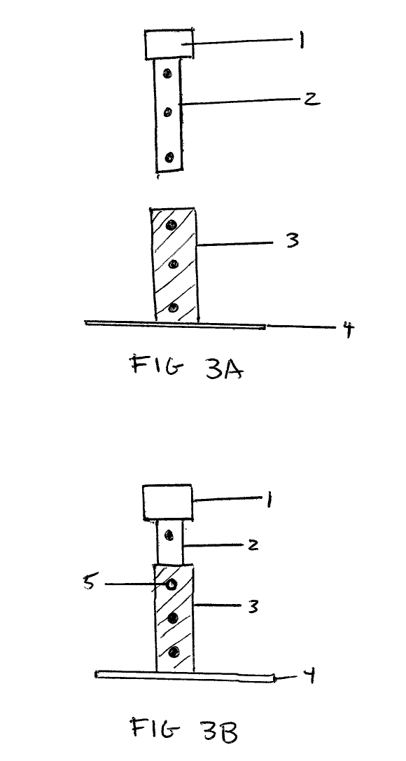

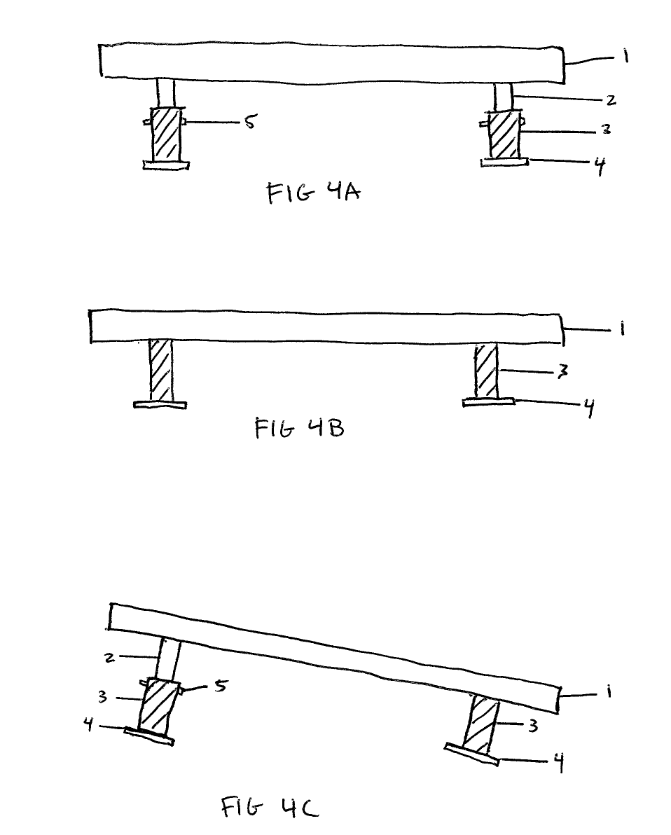

Description of the Invention—operation—The tubing and legs and base plates are made of metal. The metal can be steel, aluminum, or any other material that can hold the weight of the rider sliding on the surface without permanently bending or breaking it. The walls of the steel tubing that can range from 1/16 an inch to ½ and an inch. The metal can be purchased and then cut and then welded. The adjustable skateboard rail has legs that are composed of metal. Two pieces of metal tubing ranging from 3 inches to 2 feet are welded on the bottom of a long piece of metal tubing ranging from 5 feet in length to 20 feet in length. The legs are inserted into a slot which is slightly larger than the legs attached to the top tubing. This larger tubing is attached to base plates made of metal which are held together by welds. Both parts of the leg assembly have holes drilled in them. A bolt or pin made of metal is then inserted into the aligned holes of both the base legs and the top tubing legs and hold the skateboard rail at a desired height.

Operation of Invention—The manner of using the rail is for the rider to jump on top of the rail and land on top of it with the skateboard being beneath the rider's feet and on top of the slidable surface. The rider then slides on the rail and comes off.

To adjust the height, one must pull the pin or screw out of the hole, raise or lower the leg to the preferred height, and place the pin or bolt into the holes that are aligned. A nut or pin can be placed on the end of the bolt or pin to prevent it from falling out of the hole. The base plates prevent the rail from falling over when the rider jumps on top of the rail attempting to slide on it.

Conclusion, Ramifications, and Scope of Invention

The reader will see that the rail can be used to slide on by skateboarders. It can be moved to various locations.

Furthermore, the legs of the rail can be adjustable thus giving additional advantages in that:

a) it permits skateboarders at different skill levels to perform tricks at different heights using one obstacle.

b) it permits the rail to be set at different angles thus increasing or decreasing the level of difficulty to perform a trick on the obstacle.

c) it permits the base plates to be aligned with the length of the rail thus making it take up less space in storage or shipping,

1. A slidable skateboard obstacle comprising:
a) metal tubing enabling the skateboarder to slide across the surface
b) legs which are welded to hold the metal tubing above ground level
c) base plates which are welded to the bottom of the legs and hold the legs vertically and prevent the slidable surface of the tubing from falling over.

2. the obstacle as defined in claim 1, additionally comprising adjustable legs which can hold the sliding surface at different heights or angles.
